(19) United States
(12) Patent Application Publication
(10) Pub. No.: US 2012/0002103 A1
(43) Pub. Date: Jan. 5, 2012

(54) METHOD AND APPARATUS FOR PROVIDING QUALITY OF SERVICE FOR WIRELESS VIDEO TRANSMISSION USING MULTI-BAND OPERATION

(75) Inventors: Huai-Rong Shao, San Jose, CA (US); Ju-Lan Hsu, San Jose, CA (US); Chiu Ngo, San Francisco, CA (US)

(73) Assignee: SAMSUNG ELECTRONICS CO., LTD., Suwon (KR)

(21) Appl. No.: 13/175,577

(22) Filed: Jul. 1, 2011

Related U.S. Application Data
(60) Provisional application No. 61/360,830, filed on Jul. 1, 2010.

(51) Int. Cl. H04N 7/12; H04N 11/02; H04N 7/035

(52) U.S. Cl. 348/388.1; 348/487; 348/464; 348/E07.045; 348/E07.02; 348/E11.006

(57) ABSTRACT

A system implementing a method for multi-band wireless communication packetizes a block of source video information into a first packet, and packetizes the block of source video information into a second packet corresponding to the first packet, wherein the first packet and the second packet include corresponding video information. The first packet and the second packet are transmitted from a transmitting multi-band wireless station comprising a first radio for communication over a first wireless band, and a second radio for communication over a second wireless band. The first packet is transmitted over the first wireless band and the second packet is transmitted over the second wireless band. The first wireless band operates at a higher transmission rate than the second wireless band. A multi-band receiving wireless station reconstructs the source video based on packets arriving on different bands.

### RELATED APPLICATION

This application claims priority to, and claims benefit of, U.S. Provisional Patent Application Ser. No. 61/360,830 filed on Jul. 1, 2010, incorporated herein by reference.

### FIELD OF INVENTION

This invention relates in general to wireless communications, and in particular, to improving Quality of Service (QoS) for wireless video transmissions.

### BACKGROUND OF INVENTION

Meeting QoS criteria for video transmission over wireless communication links is important for meeting user requirements. As an example, most television (TV) manufacturers require smooth video streaming over wireless links without any visual quality degradation for over 40 continuous hours. However, wireless communication links, such as wireless radio frequency channels in Wi-Fi and millimeter wave (mmW), can suffer from interference or blockage problems and encounter packet loss, resulting in increased communication latency and degrading QoS.

### BRIEF SUMMARY

According to an embodiment of the invention, a system implementing a method for multi-band wireless communication packetizes a block of source video information into a first packet, and packetizes the block of source video information into a second packet corresponding to the first packet, wherein the first packet and the second packet include corresponding video information. The first packet and the second packet are transmitted from a transmitting multi-band wireless station comprising a first radio for communication over a first wireless band, and a second radio for communication over a second wireless band. The first packet is transmitted over the first wireless band and the second packet is transmitted over the second wireless band. The first wireless band operates at a higher transmission rate than the second wireless band. A multiband receiving wireless station reconstructs the source video based on packets arriving on different bands.

These and other features, aspects and advantages of the present invention will become understood with reference to the following description, appended claims and accompanying figures.

### BRIEF DESCRIPTION OF THE DRAWINGS

FIG. 1 shows a block diagram of a multi-band wireless communication system, according to an embodiment of the invention.

FIG. 2 shows a process for multi-band wireless transmission of uncompressed source content, as compressed and uncompressed packets, from a multi-band transmitting wireless station, according to an embodiment of the invention.

FIG. 3 shows a synchronization process for multi-band wireless transmission of source content in FIG. 2, according to an embodiment of the invention.

FIG. 4 shows a process for multi-band wireless transmission of uncompressed source content, as compressed packets, from a multi-band transmitting wireless station, according to an embodiment of the invention.

FIG. 5 shows a process for multi-band wireless transmission of uncompressed source content, as compressed packets, from a multi-band transmitting wireless station, according to another embodiment of the invention.

FIG. 6 shows a synchronization process for multi-band wireless transmission of source content as compressed packets in FIGS. 4-5, according to an embodiment of the invention.

FIG. 7 shows a process for multi-band wireless transmission of uncompressed source content, as compressed packets, from a multi-band transmitting wireless station, according to another embodiment of the invention.

FIG. 8 shows a synchronization process for multi-band wireless transmission of source content as compressed packets in FIG. 7, according to an embodiment of the invention.

FIG. 9 shows a process for multi-band wireless transmission and retransmission of source content, according to an embodiment of the invention.

FIG. 10A shows a process for multi-band wireless transmission and retransmission of source content, according to another embodiment of the invention.

FIG. 10B shows a process for multi-band wireless reception of packets and reconstruction of source content based on received packet, according to another embodiment of the invention.

FIG. 11 shows a detailed block diagram of a multi-band wireless communication system and modules, according to an embodiment of the invention.

FIG. 12 shows a block diagram of an information processing system comprising a computer system useful for implementing an embodiment of the present invention.

### DETAILED DESCRIPTION

Embodiments of the invention provide a method and system for providing QoS for wireless video transmission using multi-band operation. According to an embodiment of the invention, a system implementing a method for multi-band wireless communication packetizes a block of source video information into a first packet, and packetizes the block of source video information into a second packet corresponding to the first packet, wherein the first packet and the second packet include corresponding video information. The first packet and the second packet are transmitted from a transmitting multi-band wireless station comprising a first radio for communication over a first wireless band, and a second radio for communication over a second wireless band. The first packet is transmitted over the first wireless band and the second packet is transmitted over the second wireless band. The first wireless band operates at a higher transmission rate than the second wireless band. A multi-band receiving wireless station reconstructs the source video based on packets arriving on different bands.

In one embodiment of the invention, wireless transmission between wireless devices (wireless stations) such as a transmitting wireless station and a receiving wireless station, comprises a multi-radio operation (e.g., first and second wireless bands, with the first wireless band providing a higher transmission rate than the second wireless band), to improve QoS for uncompressed and/or compressed wireless video transmission. For example, IEEE 802.11ad specifies fast session transfer (FST) mechanism for multi-band wireless devices which implies that an example IEEE 802.11ad compatible wireless device includes both a Wi-Fi radio (e.g., 2.4 GHz or 5 GHz band) and a mmW radio (e.g., 60 GHz band). In one embodiment, a frame structure is used for data transmission between wireless stations such as a transmitting station and a receiving station. In one example, a frame structure in a Media Access Control (MAC) layer and a physical (PHY) layer is utilized (such as in IEEE 802.11 standard), wherein in a transmitting station, a MAC layer receives a MAC Service Data Unit (MSDU) and attaches a MAC header thereto, in order to construct a MAC Protocol Data Unit (MPDU). The MAC header includes information such as a source address (SA) and a destination address (DA) for the receiving station. The MPDU is a part of a PHY Service Data Unit (PSDU) and is transferred to a PHY layer in the transmitting station to attach a PHY header (i.e., PHY preamble) thereto to construct a PHY Protocol Data Unit (PPDU). The PHY header includes parameters for determining a transmission scheme including a coding/modulation scheme. Before transmission as a frame from the transmitting station to the receiving station, a preamble is attached to the PPDU, wherein the preamble can include channel estimation and synchronization information. The PHY layer in the transmitting station and the receiving station includes transmission hardware for communication data bits over a wireless link.

In one embodiment of the invention, each wireless station includes a transceiver comprising both a Wi-Fi radio and a mmW radio. In one implementation, a transmitting wireless station (i.e., transmitter) transmits uncompressed high-definition video over a first wireless band such as mmW (e.g., ultra band or UB wireless channel) and simultaneously transmits compressed video of the same content, or partial information of the uncompressed video, over a second wireless band such as Wi-Fi in either 2.4 GHz or 5 GHz band (e.g., low band or LB, or high band or HB, wireless channel), to a receiving wireless station (i.e., receiver).

In one embodiment of the invention, both the UB and LB/HB radio frequency (RF) wireless channels are used for compressed video communication between the transmitter and the receiver. In one example, both UB and LB/HB wireless channels are used for synchronized transmission of the same video information from the transmitter to the receiver. In another example, a primary wireless channel is used for the compressed video transmission without acknowledgement (ACK) and re-transmission scheme, and a secondary wireless channel is used for ACK packet transmission and also re-transmission of erroneous or lost video packets (e.g., audio/video packets). For example, a LB/HB wireless channel is used as primary channel for compressed video transmission and a UB wireless channel is used as secondary channel for ACK transmission and re-transmission of the erroneous or lost video packets, or vice-versa.

In one embodiment of the invention in which the UB and HB/LB cannot operate in parallel (i.e., simultaneously), a switching module switches between uncompressed video and compressed video transmission in a synchronized manner utilizing a FST process at the MAC/PHY layers of the transmitter and receiver. In the context of the description herein, FST means the switching from one radio operation to another radio operation (e.g., from UB to LB/HB or from LB/HB to UB).

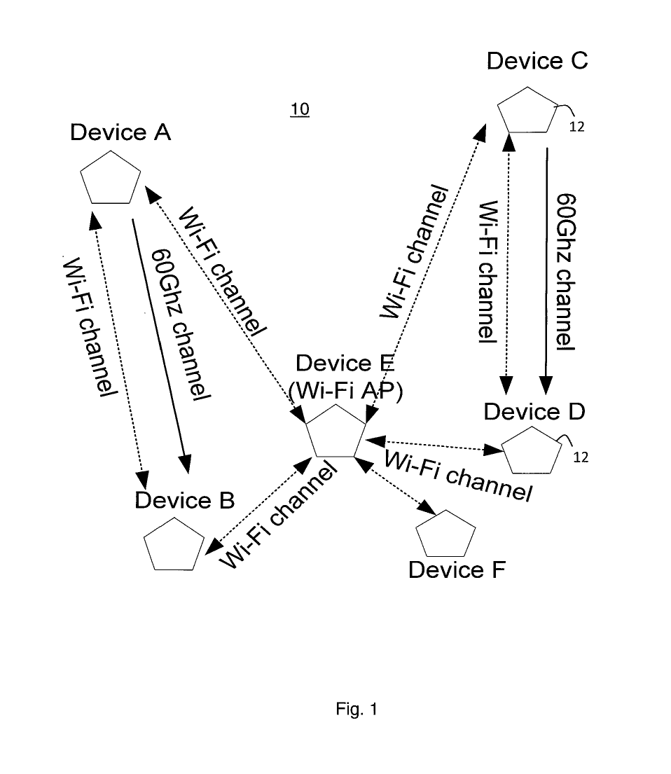

FIG. 1 shows a block diagram of a multi-band wireless communication system 10, according to an embodiment of the invention. The system 10 includes wireless stations 12 such as wireless Device A, Device B, Device C, Device D, Device E and Device F. Each of the wireless stations includes both a Wi-Fi radio (e.g., 2.4 GHz/5 GHz (LB/HB) based on IEEE 802.11a/b/g/n or IEEE 802.11ac) and a mmW radio (e.g., 60 GHz (UB) based on IEEE 802.11ad (WiGig), ECMA, WirelessHD, etc.), wherein the two radios can function simultaneously. At the Wi-Fi frequency band (e.g., 2.4 or 5 GHz), an omni-directional Wi-Fi channel is available for signaling purposes for all wireless stations in the system 10. Wi-Fi communication can be performed using either Infrastructure mode or ad-hoc mode. In the system 10, Device E functions as an access point (AP) for Wi-Fi communications. In the following, embodiments of a wireless communication process for improving QoS for data communication (e.g., Audio/Video data) between wireless stations, is described. In one example, video information may comprise a block of data such as video data. The video information may further include audio information.

### Communication Scheme 1

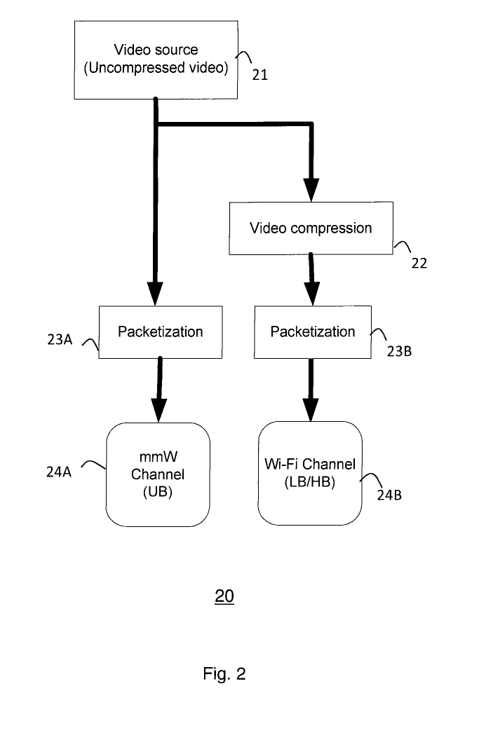

Referring to FIG. 2, according to an embodiment of the invention, a mmW band (i.e., UB such as 60 GHz) is utilized to transmit uncompressed high-definition video and simultaneously a Wi-Fi band (LB and HB, such as either 2.4 or 5 GHz band) is used to transmit the compressed video of the same content, or partial information of the uncompressed video. Specifically, FIG. 2 illustrates a communication process block diagram 20 implemented at a transmitter 12 in the system of FIG. 1, wherein in process block 21 the input to the transmitter from a video source comprises uncompressed video information (content). In a first processing path, the uncompressed video information is placed into packets (frames) in process block 23A. The uncompressed video packets are directly transmitted on the mmW channel in process block 24A from the transmitter. In addition, in a parallel (essentially simultaneous) processing path, the same uncompressed video information is first compressed in a process block 22, and then the compressed video information is placed into packets in process block 23B, and the packets are transmitted on the Wi-Fi channel in process block 24B from the transmitter.

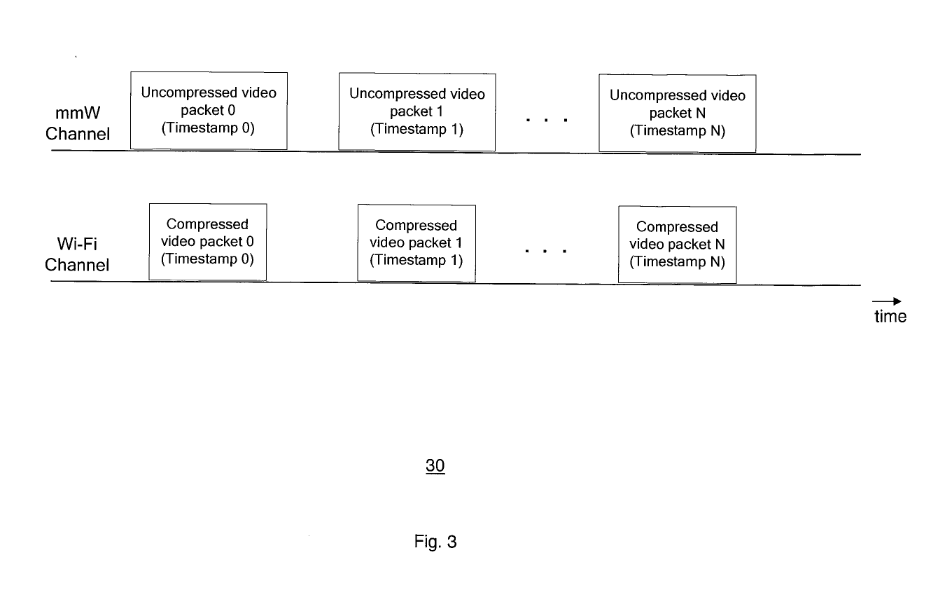

According to an embodiment of the invention, communication of uncompressed video over the mmW channel and transmission of compressed video over the Wi-Fi channel is synchronized during transmission. Synchronization can be performed at different levels, for example, video frame level or video slice level. In one example, synchronization is achieved by using timestamps and the frame/slice numbers or packet numbers, as shown by an example timing diagram 30 in FIG. 3, using targeting display timestamp (targeting display timestamp carries a time value by which the video information should be displayed). FIG. 3 shows transmission of N uncompressed video packets and N corresponding video packets, wherein uncompressed video packet 0 and its corresponding compressed video packet 0 have the same timestamp 0, and so on.

Based on the timestamps, a receiving multi-band wireless station (receiver) can reconstruct said source content from the received packets. Specifically, the receiver matches the timestamps between packets on the two different channels (mmW and Wi-Fi) to identify packets that include corresponding source content. As such, two packets arriving on different channel wherein the packet have the same timestamp include corresponding video information (e.g., a first received packet includes uncompressed source video information and a second received packet includes a compressed version of said uncompressed source video information, or a first received packet includes compressed source video information and a second received packet includes the same compressed source video information, etc.). The receiver then reconstructs the source content based on the video information in one or more of the received video packets identified as having the same (i.e., matching) timestamps.

According to an embodiment of the invention, video encoding latency and video decoding latency are taken into consideration when scheduling the compressed video packets at the Wi-Fi channel for synchronization with the corresponding uncompressed video packets at the mmW channel. At the receiver side, the compressed video packets can be skipped without decoding if the corresponding uncompressed video packets at the mmW channel are successfully received. No re-transmission is needed for this scheme. According to an example of using latency for scheduling and synchronizing, if the timestamp is set to T and video decoding latency is Td, then there is a requirement for scheduling that the compressed video cannot arrive later than T-Td.

### Communication Scheme 2

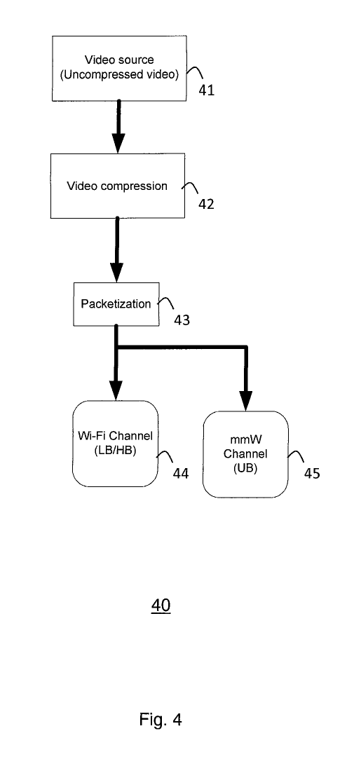

Referring to FIG. 4, according to an embodiment of the invention, the mmW channel is used to transmit compressed high-definition video information, and simultaneously, the Wi-Fi channel (in either 2.4 or 5 GHz bands) is used to transmit the same compressed video information. Specifically, FIG. 4 illustrates a communication process block diagram 40 implemented at a transmitter 12 in the system of FIG. 1, wherein in process block 41 the input to the transmitter from a video source comprises uncompressed video information (content). The uncompressed video information is first compressed in a process block 42, and then the compressed video information is placed into packets in process block 43. The packets are transmitted on the Wi-Fi channel in process block 44 from the transmitter. In parallel, the same packets are also transmitted on the mmW channel in process block 45 from the transmitter. As such, after compression and packetization, the same copies of the compressed video packets are directly transmitted on the mmW channel and Wi-Fi channel from the transmitter to the receiver.

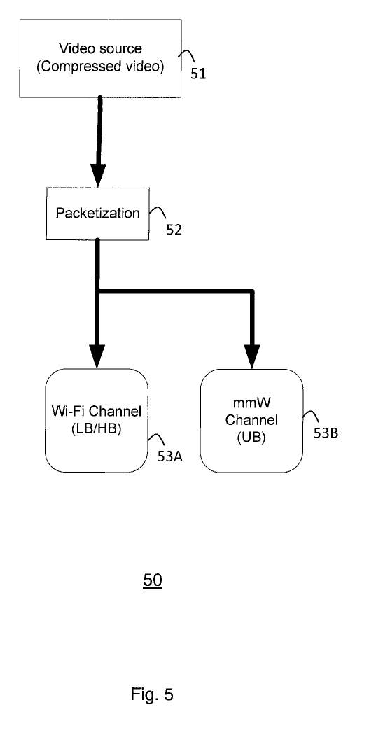

FIG. 5 illustrates a communication process at a transmitter (such as transmitter 12 in FIG. 1), wherein the input from video source at the transmitter is compressed video, according to an embodiment of the invention. Specifically, FIG. 5 illustrates a communication process block diagram 50 implemented at a transmitter 12 in the system of FIG. 1, wherein in process block 51 the input to the transmitter from a video source comprises compressed video information (content). The compressed video information is placed into packets in process block 52. The packets are transmitted on the Wi-Fi channel in process block 53A from the transmitter. In parallel, the same packets are also transmitted on the mmW channel in process block 53B from the transmitter. As such, the same copies of the compressed video packets are directly transmitted on the mmW channel and Wi-Fi channel from the transmitter to the receiver.

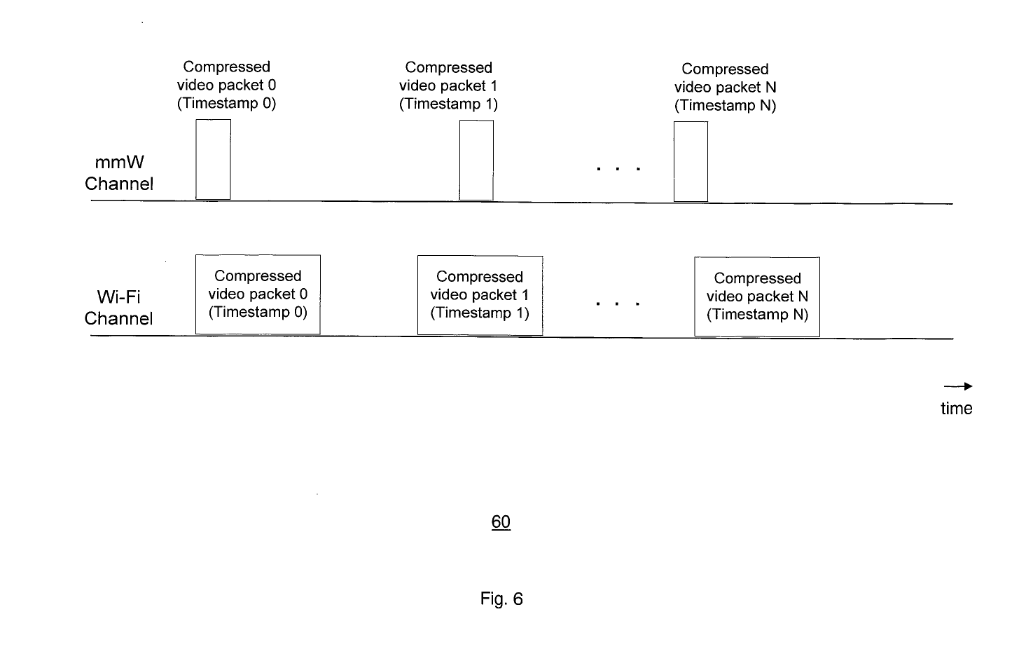

Referring to FIG. 6, according to an embodiment of the invention, the same copies of the compressed video packets transmitted over the mmW channel and over the Wi-Fi channel, are synchronized during transmission. Synchronization can be performed at the packet level as shown by example in FIG. 6. Since the mmW channel typically operates at a higher transmission rate than the Wi-Fi channel, the transmission time for a compressed video packet at the mmW channel is shorter than the corresponding transmission time at the Wi-Fi channel. FIG. 6 shows transmission of N compressed video packets and N corresponding compressed video packets, wherein compressed video packet 0 on the mmW channel and its corresponding compressed video packet 0 on the Wi-Fi channel have the same timestamp 0, and so on. Based on the timestamps, a receiver can reconstruct said source content from the receive packets. At the receiver side, the compressed video packets received from the Wi-Fi channel can be skipped without decoding if the corresponding compressed video packets are successfully received from the mmW channel.

### Communication Scheme 3

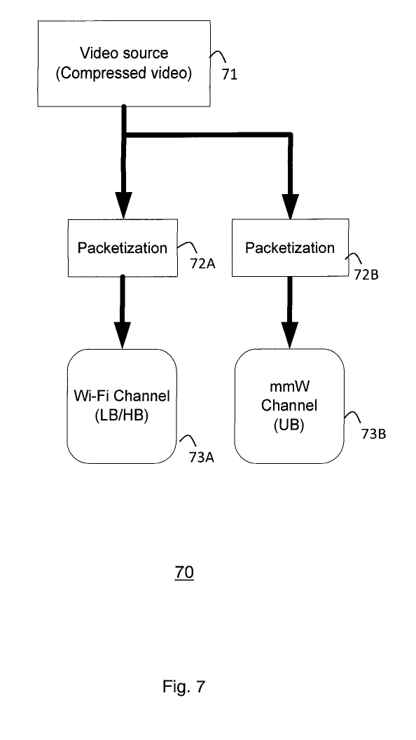

Referring to FIG. 7, according to an embodiment of the invention, the mmW channel is used to transmit compressed high-definition video, and simultaneously, the Wi-Fi channel (in either 2.4 or 5 GHz bands) is used to transmit the same compressed video. Specifically, FIG. 7 illustrates a communication process block diagram 70 implemented at a transmitter 12 in the system of FIG. 1, wherein in process block 71 the input to the transmitter from a video source comprises compressed video information (content). In one processing path, the compressed video information is placed into packets in process block 72A, and the packets are transmitted on the Wi-Fi channel in process block 73A from the transmitter. In parallel, the same compressed video information is placed into packets in process block 72B, and the packets are transmitted on the Wi-Fi channel in process block 73B from the transmitter. Therefore, the compressed video packets with same information are directly transmitted on the mmW channel and Wi-Fi channel from the transmitter to the receiver.

Compression is performed before packetization. Typically, both the transmitter and receiver have memory buffers for the compressed video packets. Since the mmW channel is faster than the Wi-Fi channel, the video packet size at the mmW channel is larger than the video packet size at the Wi-Fi channel.

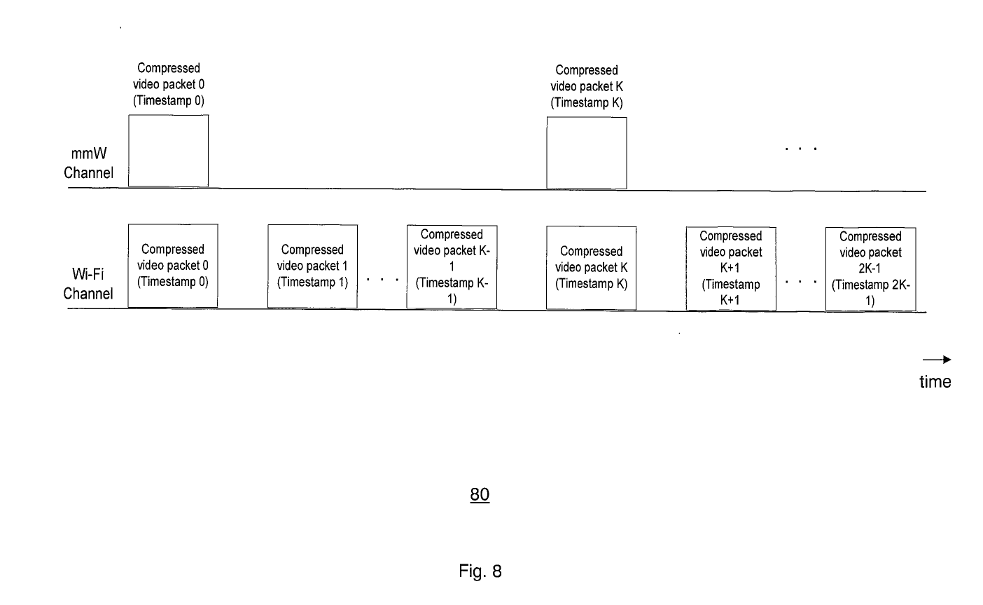

Referring to the synchronization timing diagram 80 in FIG. 8, in one embodiment of the invention, one video packet at the mmW channel includes the video content information carried by multiple video packets at the Wi-Fi channel. In FIG. 8 one video packet at the mmW channel includes the video content carried by K video packets at the Wi-Fi channel. At the receiver, the compressed video packets received from the Wi-Fi channel can be skipped without decoding if the corresponding compressed video packets are successfully received from the mmW channel.

### Communication Scheme 4

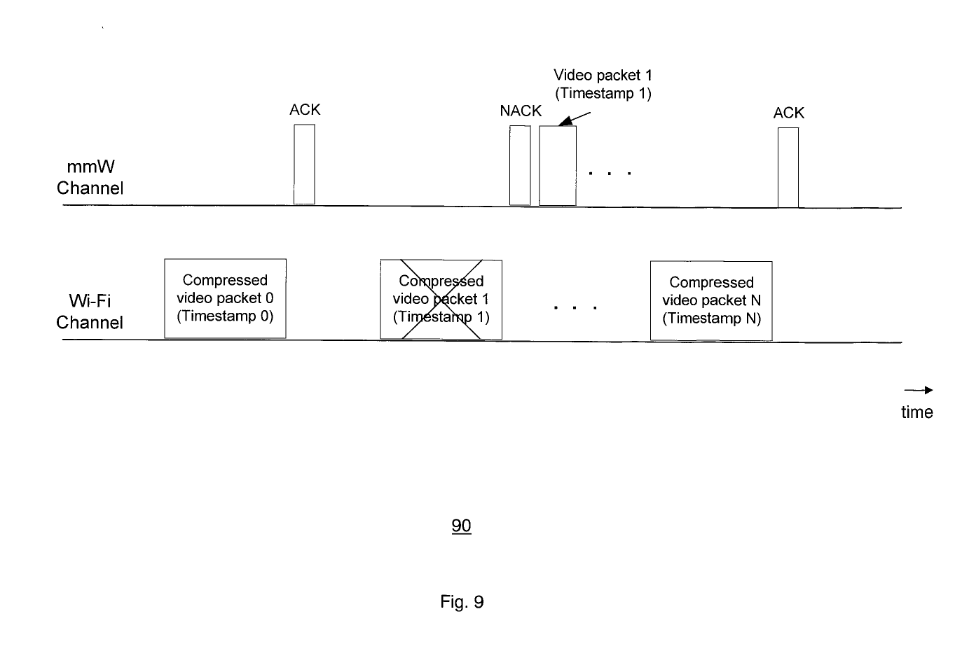

Referring to the synchronization timing diagram 90 in FIG. 9, in one embodiment of the invention, the Wi-Fi channel is used as the primary channel for the compressed video transmission without ACK and re-transmission. The mmW channel is used as the secondary channel for ACK packet transmission and also the re-transmission of the erroneous or lost video packets. In FIG. 9, compressed video packet 1 experiences errors during transmission at the Wi-Fi channel, wherein a negative ACK (NACK) is sent back from the receiver to the transmitter over the mmW channel and the re-transmission of the video packet 1 (either compressed or uncompressed) is performed by the transmitter over the mmW channel. The ACK packets in FIG. 9 can be skipped and only NACK used to trigger re-transmission.

### Communication Scheme 5

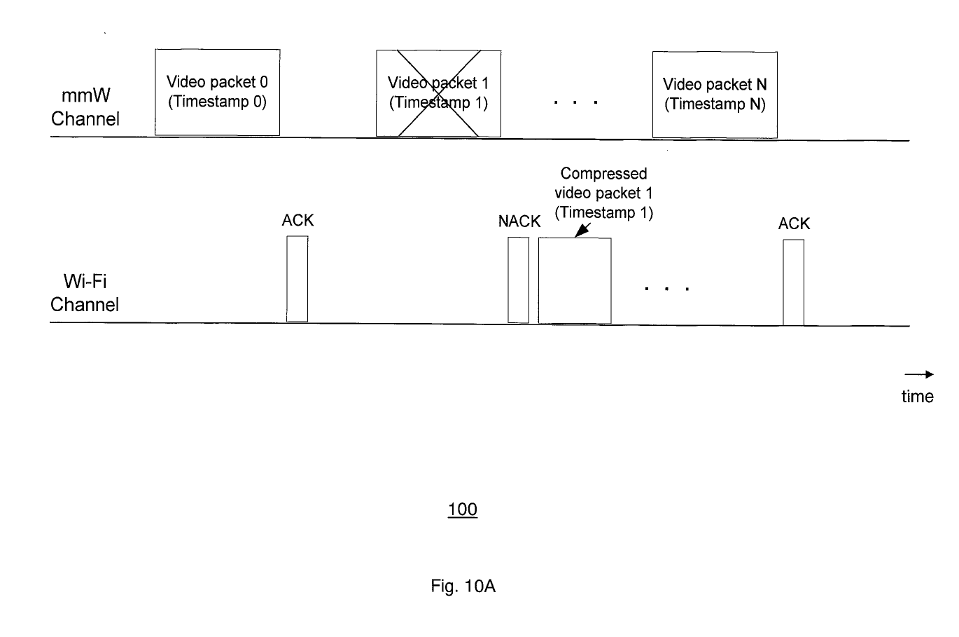

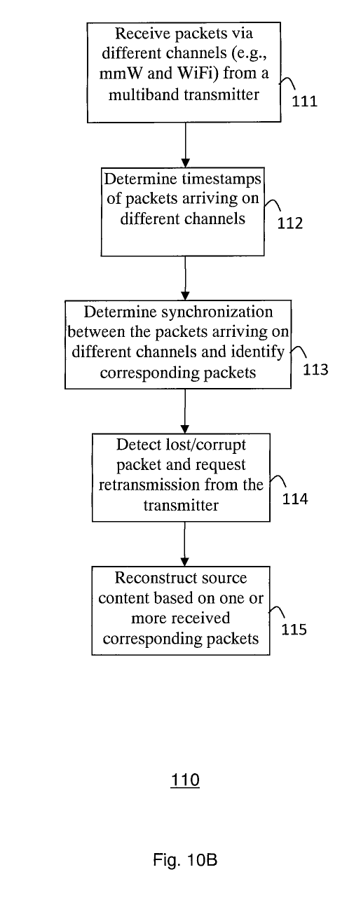

Referring to the synchronization timing diagram 100 in FIG. 10A, in one embodiment of the invention, the mmW channel is used as the primary channel for the uncompressed or compressed video transmission without acknowledgement and re-transmission. The Wi-Fi channel is used as the secondary channel for ACK packet transmission and re-transmission of erroneous or lost video packets. As an example in FIG. 10A, video packet 1 (either uncompressed or compressed) has errors during transmission at mmW channel, wherein a NACK is sent back to the transmitter at the Wi-Fi channel. Re-transmission of the video packet 1 (either compressed or uncompressed) is performed at the Wi-Fi channel by the transmitter. The ACK packets in FIG. 10A can be skipped and only NACK is needed to trigger re-transmission.

In the above-described example schemes, in each wireless station two wireless radios (mmW and Wi-Fi) can operate simultaneously. In case the two wireless radios cannot operate simultaneously, a switching process between mmW radio operation and Wi-Fi radio operation can be synchronized using the FST process as described in the IEEE 802.11ad specification. The MAC layer instructs the PHY layer radio to switch between the mmW and Wi-Fi radios. The receiver may buffer a number of incoming packets during the switching process.

Referring to the process 110 in FIG. 10B, in one embodiment of the invention, the receiving multiband wireless station implements process blocks including:
Process block 111: Receive arriving packets via the mmW channel radio and/or the Wi-Fi channel radio.
Process block 112: Determine the timestamp in each packet arriving on different channels.
Process block 113: Determine packet synchronization by matching the timestamps between arriving packets to identify packets that include corresponding source content.
Process block 114: Detect lost/corrupted packets and send NACK to transmitter for retransmission.
Process block 115: De-packetize and reconstruct the source content based on the video information in one or more of the received video corresponding packets (i.e., identified as having the same/matching timestamp).

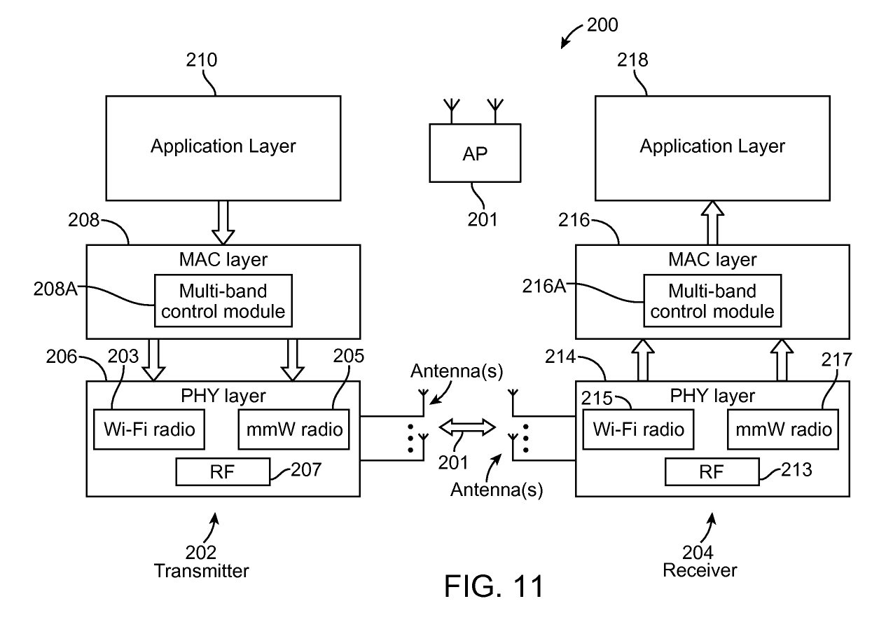

FIG. 11 shows a block diagram of an example wireless communication system 200 that may be used to implement the above-described multi-band video transmission schemes. The system 200 includes wireless stations or wireless devices such as a wireless transmitting station (transmitter or sender) 202 and a wireless receiving station (receiver) 204, for data transmission, such as transmission of data, audio/video information, etc. The system 200 further includes an AP station 201 for Wi-Fi communications.

The AP 201 and the stations 202 and 204 implement a frame structure that is used for data transmission therebetween, using packet transmission in a MAC layer and a PHY layer. In a typical AP, a MAC layer receives a data packet including payload data, and attaches a MAC header thereto, in order to construct a MPDU. The MAC header includes information such as a SA and a DA. The MPDU is a part of a PSDU and is transferred to a PHY layer in the AP to attach a PHY header (i.e., a PHY preamble) thereto to construct a PPDU. The PHY header includes parameters for determining a transmission scheme including a coding/modulation scheme.

The transmitter 202 includes an application layer 210, a MAC layer 208 and a PHY layer 206. The application layer 210 packetizes information, wherein the packets are then converted to MAC packets by the MAC layer 208. The application layer 210 may further send transmission requests and control commands to reserve wireless channel time blocks for transmission of packets.

The PHY layer 206 includes a Wi-Fi radio module 203, a mmW radio module 205 and a RF communication module 207. The RF communication module 207 transmits/receives signals under control of the radio modules 203 and 205. The PHY layer 206 may further include a baseband module.

The receiver 204 includes a PHY layer 214, a MAC layer 216 and an application layer 218. The PHY layer 214 includes a Wi-Fi radio module 215, a mmW radio module 217, and a RF communication module 213 which transmits/receives signals under control of the radio modules 215 and 217.

The application layer 218 de-packetizes information in the MAC packets, received by the MAC layer 216. The depacketizing is reverse of the packetization. The application layer 218 may further handle wireless channel access.

The MAC layers 208 and 216 include respective multi-band control modules 208A and 216A. The multi-band control module 208A implements multi-band control processes including compression, packetization, synchronization, band switching as needed, transmitting and retransmitting source video data using the Wi-Fi and mmW channels from the transmitting station 202, as described above. The multi-band control module 216A implements multi-band control processes including receiving said video data using the Wi-Fi and mmW channels, band switching as needed, sending back ACK/NACK to the transmitter for packet retransmission, and reconstructing the source video data from one or more arriving packets, as described above. In other embodiments, the multi-band control modules 208A and 216A could be implemented in the respective application layers 210 and 218 or in some combination of MAC layers 208 and 216 and application layers 210 and 218.

As is known to those skilled in the art, the aforementioned example architectures described above can be implemented in many ways, such as program instructions for execution by a processor, as software modules, microcode, as computer program product on computer readable media, as logic circuits, as application specific integrated circuits, as firmware, as consumer electronic devices, etc., in wireless devices, in wireless transmitters/receivers, in wireless networks, etc. The disclosed embodiments can take the form of an entirely hardware embodiment, an entirely software embodiment or an embodiment containing both hardware and software elements.

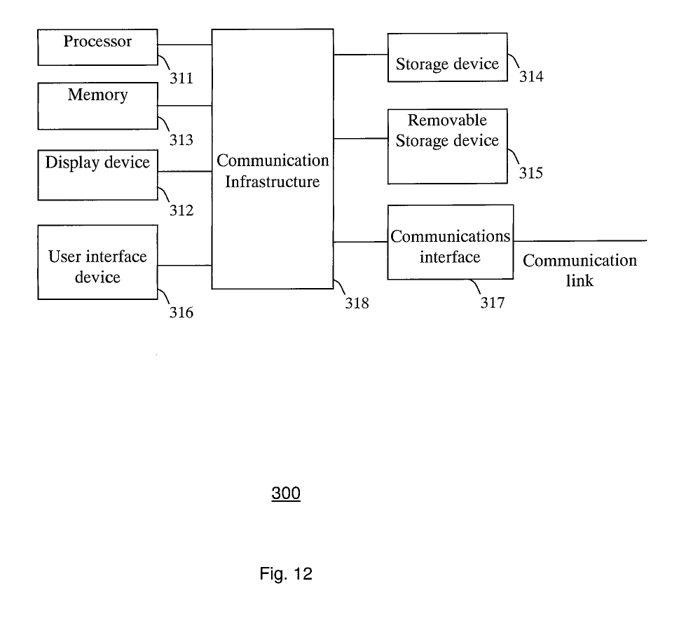

FIG. 12 is a high level block diagram showing an information processing system comprising a computer system 300 useful for implementing an embodiment of the present invention. The computer system 300 includes one or more processors 311, and can further include an electronic display device 312 (for displaying graphics, text, and other data), a main memory 313 (e.g., random access memory (RAM)), storage device 314 (e.g., hard disk drive), removable storage device 315 (e.g., removable storage drive, removable memory module, a magnetic tape drive, optical disk drive, computer readable medium having stored therein computer software and/or data), user interface device 316 (e.g., keyboard, touch screen, keypad, pointing device), and a communication interface 317 (e.g., modem, a network interface (such as an Ethernet card), a communications port, or a PCMCIA slot and card). The communication interface 317 allows software and data to be transferred between the computer system and external devices. The system 300 further includes a communications infrastructure 318 (e.g., a communications bus, cross-over bar, or network) to which the aforementioned devices/modules 311 through 317 are connected.

Information transferred via communications interface 317 may be in the form of signals such as electronic, electromagnetic, optical, or other signals capable of being received by communications interface 317, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart /block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method of wireless communication, comprising:
packetizing a block of source video information into a first packet;
packetizing the block of source video information into a second packet corresponding to the first packet, wherein the first packet and the second packet include corresponding video information; and
transmitting the first packet and the second packet from a transmitting multi-band wireless station comprising a first radio for communication over a first wireless band, and a second radio for communication over a second wireless band, the first packet being transmitted over the first wireless band and the second packet being transmitted over the second wireless band, wherein the first wireless band operates at a higher transmission rate than the second wireless band.

2. The method of claim 1, wherein the first wireless band comprises a millimeter wave (mmW) and the second wireless band comprises a Wi-Fi band.

3. The method of claim 1, wherein transmitting the first packet and the second packet further comprises:
synchronizing transmission of the first packet and the second packet over the first wireless band and the second wireless band, respectively.

4. The method of claim 3, wherein synchronizing transmission of the first packet and the second packet comprises:
generating a timestamp and including the timestamp in the first packet and the second packet.

5. The method of claim 4, wherein packetizing the video information into the second packet further comprises:
compressing the video information to generate compressed video information; and
packetizing the compressed video information into the second packet.

6. The method of claim 5, further comprising:
receiving multiple packets at a receiving multi-band wireless station;
based on the timestamp in each packet, identifying packets with the same timestamp as packets that include corresponding video information; and
reconstructing said source video information based on one or more of the identified packets.

7. The method of claim 6, wherein reconstructing said source video information comprises:
reconstructing said source video information based on a successfully received identified packet that includes uncompressed video information.

8. The method of claim 4, further comprising:
compressing the block of source video information to generate compressed video information;
packetizing the compressed video information into the first packet, and packetizing the compressed video information into the second packet, for transmission from the multi-band wireless station.

9. The method of claim 8, wherein the block of source video information comprises uncompressed video information.

10. The method of claim 9, further comprising:
receiving multiple packets at a receiving multi-band wireless station;
based on the timestamp in each packet, identifying packets with the same timestamp as packets that include corresponding video information; and
reconstructing said source video information based on one or more of the identified packets.

11. The method of claim 10, wherein reconstructing said source video information comprises:
reconstructing said source video information based on a successfully received identified packet that includes uncompressed video information.

12. The method of claim 4, wherein the block of source video information comprises compressed video information.

13. The method of claim 12, wherein:
packetizing the block of source video information into a second packet comprises distributing the block of source video information into multiple secondary packets, wherein the first packet corresponds to multiple secondary packets.

14. The method of claim 12, further comprising:
receiving multiple packets at a receiving multi-band wireless station;
based on the timestamp in each packet, identifying packets with the same timestamp as packets that include corresponding video information; and
reconstructing said source video information based on one or more of the identified packets.

15. The method of claim 14, wherein reconstructing said source video information comprises:
reconstructing said source video information based on a successfully received identified packet that includes uncompressed video information.

16. The method of claim 1, wherein transmitting the first packet and the second packet further comprises transmitting the first packet and the second packet from the transmitting multi-band wireless station wherein the first radio and the second radio operate simultaneously.

17. The method of claim 1, wherein transmitting the first packet and the second packet further comprises transmitting the first packet and the second packet from the transmitting multi-band wireless station wherein the first radio and the second radio operate in switched manner.

18. A method of wireless communication, comprising:
packetizing a block of source video information into a first packet;
transmitting the first packet from a transmitting multi-band wireless station comprising a first radio for communication over a first wireless band, and a second radio for communication over a second wireless band, the first packet being transmitted over the first wireless band, wherein the first wireless band operates at a lower transmission rate than the second wireless band; and
upon detecting unsuccessful reception of the first packet at a receiving multi-band wireless station, retransmitting the source video information from the transmitting multi-band wireless station over the second wireless band.

19. The method of claim 18, further comprising detecting unsuccessful reception of the first packet at the receiving multi-band wireless station based on a negative acknowledgment received from the receiving multi-band wireless station on the second wireless band.

20. A method of wireless communication, comprising:
packetizing a block of source video information into a first packet;
transmitting the first packet from a transmitting multi-band wireless station comprising a first radio for communication over a first wireless band, and a second radio for communication over a second wireless band, the first packet being transmitted over the first wireless band, wherein the first wireless band operates at a higher transmission rate than the second wireless band; and
upon detecting unsuccessful reception of the first packet at a receiving multi-band wireless station, retransmitting the source video information in a packet from the transmitting multi-band wireless station over the second wireless band.

21. The method of claim 20, wherein the retransmission packet includes a compressed version of the source video information.

22. The method of claim 20, further comprising detecting unsuccessful reception of the first packet at the receiving multi-band wireless station based on a negative acknowledgment received from the receiving multi-band wireless station on the second wireless band.

23. A multi-band wireless communication station, comprising:
a first radio for communication over a first wireless band, and a second radio for communication over a second wireless band, wherein the first wireless band operates at a higher transmission rate than the second wireless band; and
a controller that packetizes a block of source video information into a first packet, and further packetizes the block of source video information into a second packet corresponding to the first packet, wherein the first packet and the second packet include corresponding video information;
wherein the controller transmits the first packet over the first wireless band and the second packet over the second wireless band.

24. The wireless communication station of claim 23, wherein the first wireless band comprises a millimeter wave (mmW) and the second wireless band comprises a Wi-Fi band.

25. The wireless communication station of claim 23, wherein the controller synchronizes transmission of the first packet and the second packet over the first wireless band and the second wireless band, respectively.

26. The wireless communication station of claim 25, wherein the controller synchronizes transmission of the first packet and the second packet by generating a timestamp and including the timestamp in the first packet and the second packet.

27. The wireless communication station of claim 26, wherein the controller packetizes the video information into the second packet by compressing the video information to generate compressed video information, and packetizing the compressed video information into the second packet.

28. The wireless communication station of claim 26, wherein:
the controller compresses the block of video information to generate compressed video information;
the controller packetizes the compressed video information into the first packet, and packetizes the compressed video information into the second packet, for transmission from the multi-band wireless communication station.

29. The wireless communication station of claim 28, wherein the block of source video information comprises uncompressed video information.

30. The wireless communication station of claim 26, wherein the block of source video information comprises compressed video information.

31. The wireless communication station of claim 30, wherein:
the controller packetizes the block of source video information into a second packet by distributing the block of source video information into multiple secondary packets, wherein the first packet corresponds to multiple secondary packets.

32. The wireless communication station of claim 23, wherein the controller transmits the first packet and the second packet such that the first radio and the second radio operate simultaneously.

33. The wireless communication station of claim 23, wherein the controller transmits the first packet and the second packet such that the first radio and the second radio operate in switched manner.

34. A multi-band wireless communication station, comprising:
a first radio for communication over a first wireless band, and a second radio for communication over a second wireless band, wherein the first wireless band operates at a higher transmission rate than the second wireless band, wherein the first wireless band operates at a lower transmission rate than the second wireless band; and
a controller that packetizes a block of source video information into a first packet;
wherein the controller transmits the first packet from over the first wireless band, and upon detecting unsuccessful reception of the first packet at a receiving multi-band wireless station, the controller retransmits the source video information over the second wireless band.

35. The multi-band wireless communication station of claim 34, wherein the controller detects unsuccessful reception of the first packet at the receiving multi-band wireless station based on a negative acknowledgment received from the receiving multi-band wireless station on the second wireless band.

36. A multi-band wireless communication station, comprising:
a first radio for communication over a first wireless band, and a second radio for communication over a second wireless band, the first packet being transmitted over the first wireless band, wherein the first wireless band operates at a higher transmission rate than the second wireless band; and
a controller that packetizes a block of source video information into a first packet, and transmits the first packet over the first wireless band;
wherein upon detecting unsuccessful reception of the first packet at a receiving multi-band wireless station, the controller retransmits the source video information in a packet over the second wireless band.

37. The multi-band wireless communication station of claim 36, wherein the retransmission packet includes a compressed version of the source video information.

38. The multi-band wireless communication station of claim 36, wherein the controller detects unsuccessful reception of the first packet at the receiving multi-band wireless station based on a negative acknowledgment received from the receiving multi-band wireless station on the second wireless band.

39. A multi-band wireless communication station, comprising:
first radio for communication over a first wireless band, and a second radio for communication over a second wireless band, wherein the first wireless band operates at a higher transmission rate than the second wireless band; and
a controller that receives multiple packets from a transmitting station, the packets including data based on source video information;
wherein based on a timestamp in each packet, the controller identifies packets with the same timestamp as packets that include corresponding video information, and reconstructs said source video information based on one or more of the identified packets.

40. The multi-band wireless communication station of claim 39, wherein the controller reconstructs said source video information based on a successfully received identified packet that includes uncompressed video information.

41. A multi-band wireless communication system, comprising:
a multi-band transmitting wireless station and a multi-band receiving wireless station;
wherein the multi-band transmitting wireless station comprises:
a first radio for communication over a first wireless band, and a second radio for communication over a second wireless band, wherein the first wireless band operates at a higher transmission rate than the second wireless band; and
a transmit controller that packetizes a block of source video information into a first packet, and further packetizes the block of source video information into a second packet corresponding to the first packet, wherein the first packet and the second packet include corresponding video information;
wherein the transmit controller transmits the first packet over the first wireless band and the second packet over the second wireless band;
wherein the multi-band receiving wireless station comprises:
a first radio for communication over said first wireless band, and a second radio for communication over said second wireless band; and
a receive controller that receives multiple packets from the transmitting wireless station, the packets including data based on source video information;
wherein based on a timestamp in each packet, the receive controller identifies packets with the same timestamp as packets that include corresponding video information, and reconstructs said source video information based on one or more of the identified packets.

42. The system of claim 41, wherein the first wireless band comprises a millimeter wave (mmW) and the second wireless band comprises a Wi-Fi band.

43. The system of claim 41, wherein the transmit controller synchronizes transmission of the first packet and the second packet over the first wireless band and the second wireless band, respectively.

44. The system of claim 43, wherein the transmit controller synchronizes transmission of the first packet and the second packet by generating a timestamp and including the timestamp in the first packet and the second packet.

45. The system of claim 44, wherein the transmit controller packetizes the video information into the second packet by compressing the video information to generate compressed video information, and packetizing the compressed video information into the second packet.

46. The system of claim 44, wherein:
the transmit controller compresses the block of source video information to generate compressed video information;
the transmit controller packetizes the compressed video information into the first packet, and packetizes the compressed video information into the second packet, for transmission from the multi-band wireless communication station.

47. The system of claim 46, wherein the block of source video information comprises uncompressed video information.

48. The system of claim 44, wherein the block of source video information comprises compressed video information.

49. The system of claim 48, wherein:
the transmit controller packetizes the block of source video information into a second packet by distributing the block of source video information into multiple secondary packets, wherein the first packet corresponds to multiple secondary packets.

50. The system of claim 41, wherein the transmit controller transmits the first packet and the second packet such that the first radio and the second radio operate simultaneously.

51. The system of claim 41, wherein the transmit controller transmits the first packet and the second packet such that the first radio and the second radio operate in switched manner.
